(19) United States
(12) Patent Application Publication
(10) Pub. No.: US 2024/0240375 A1
(43) Pub. Date: Jul. 18, 2024

(54) SPUN-BONDED COMPOSITE WIPING NON-WOVEN FABRIC AND MANUFACTURING METHOD THEREFOR

(71) Applicant: XIAMEN YANJAN NEW MATERIAL CO., LTD, fUJIAN (CN)

(72) Inventors: Qingzhong ZHENG, Fujian (CN); Chaosheng WU, Fujian (CN); Shihuang LI, Fujian (CN); Yonggong CHEN, Fujian (CN)

(21) Appl. No.: 18/288,192

(22) PCT Filed: Jan. 27, 2022
(86) PCT No.: PCT/CN2022/074237

§ 371 Date: Oct. 25, 2023

(30) Foreign Application Priority Data
Jul. 19, 2021 (CN) 202110813896.5

(51) Int. Cl. D04H 1/4374; B32B 5/02; B32B 5/08; B32B 5/26; D04H 1/26; D04H 1/4258; D04H 1/4382; D04H 3/007; D04H 3/16

(52) U.S. Cl. CPC D04H 1/4374; B32B 5/022; B32B 5/08; B32B 5/269; B32B 5/271; D04H 1/26; D04H 1/4258; D04H 1/43835; D04H 3/007; D04H 3/16; B32B 2250/20; B32B 2262/0253; B32B 2262/04; B32B 2262/067; B32B 2262/124; B32B 2262/144; B32B 2262/16; B32B 2307/54; B32B 2307/554; B32B 2307/718; B32B 2307/726; B32B 2432/00; D10B 2201/24; D10B 2321/022; D10B 2401/063; D10B 2509/026

(57) ABSTRACT

A spunbound composite wiping non-woven fabric with a layered structure of an upper surface layer, a middle fiber layer, and a lower surface layer arranged in sequence; at least one of the upper surface layer and the lower surface layer is formed by a spunbound filaments, and the middle fiber layer is formed at least by viscose fibers; a weight of the middle fiber layer is greater than or equal to 65% of a total weight of the spunbound composite wiping non-woven fabric; fiber interfacing and intertwining areas exist between the upper surface layer and the middle fiber layer, as well as between the lower surface layer and the middle fiber layer.

### TECHNICAL FIELD

The present invention relates to the technical field of non-woven fabrics, and in particular to a composite wiping non-woven fabric with low shedding rate and good mechanical properties used for personal care and infant care, and a manufacturing method therefor.

### BACKGROUND OF THE INVENTION

Wiping non-woven fabrics can be used in products such as soft wet tissues, makeup removal pads, and cleansing wet tissues, enabling easy removal of bacteria and dirt. They serve for light makeup removal, daily cleaning, disinfection, and maintaining hygiene. The wiping non-woven fabrics have gained popularity among consumers due to their convenience in carrying, storage, and use. The wiping non-woven fabrics can be spunlace non-woven fabric products, melt-blown non-woven fabric or spunbond non-woven fabric products. Compared to traditional cloth wipes, the production of wiping non-woven fabrics is more convenient and cost-effective, and these fabrics are suitable for both dry and wet usage. The melt-blown and spunbond type wipe features a denser melt-blown layer formed by melt-blown fibers on the surface, which to some extent prevents the shedding of auxiliary fibers, such as wood pulp staples, from the interior portion during use. However, the auxiliary fibers within the interior portion are not mutually adhered or fixed, resulting in occurrences of “dusting” and “shedding” of fibers during use. Additionally, there is a tendency for the fibers to agglomerate during wiping after water absorption, thereby affecting the using effect and reducing the service life of the wipes. Moreover, the mechanical properties of the wiping non-woven fabric whose surface layers are formed by adhesion of melt-blown staples are poor, therefore affecting the wiping and cleaning effect of the wiping non-woven fabric.

### BRIEF SUMMARY OF THE INVENTION

### Technical Problems to be Solved

It is an object of the present invention to provide a composite wiping non-woven fabric with effective anti-shedding and anti-agglomeration properties as well as higher mechanical strength, and a manufacturing method therefor, thereby overcoming the defects of existing products and production methods.

### Technical Solutions to the Technical Problems

### Technical Solutions

To achieve the aforementioned object, the present invention provides a spunbond composite wiping non-woven fabric with a layered structure, comprising sequentially an upper surface layer, a middle fiber layer, and a lower surface layer; at least one of the upper surface layer and the lower surface layer is mainly formed by spunbond filaments, and the middle fiber layer is formed at least by viscose fibers, wherein a weight of the middle fiber layer is greater than or equal to 65% of a total weight of the spunbond composite wiping non-woven fabric; the viscose fibers have a fiber length of 35 mm to 76 mm, and there are fiber interlacing and intertwining areas between the upper surface layer and the middle fiber layer, as well as between the lower surface layer and the middle fiber layer.

The spunbond filaments are polyolefin fibers, polyamide fibers, polyurethane fibers, or a mixture thereof.

The spunbond filaments are single-component spunbond filaments, bi-component spunbond filaments with outer surface of each filament at least partially formed by low melting point resin, or a mixture thereof.

The bi-component spunbond filaments are bi-component sheath-core type spunbond filaments, bi-component orange peel type spunbond filaments, or bi-component side-by-side type spunbond filaments.

The middle fiber layer is formed by a mixture of viscose fibers mixed with natural fibers, single-component staples, bi-component staples, or a mixture thereof.

A weight percentage of the viscose fibers in the middle fiber layer is greater than or equal to 15%.

The natural fibers are wood pulp fibers, cotton fibers, or a mixture thereof.

Another one of the upper surface layer and the lower surface layer is mainly formed by spunbond filaments.

Another one of the upper surface layer and the lower surface layer is mainly formed by melt-blown fibers.

A method for manufacturing the spunbond composite wiping non-woven fabric, comprising the following steps: (1) carding the viscose fibers into a fiber web using a carding machine, and forming the middle fiber layer from the fiber web through a nozzle under action of auxiliary airflow, wherein the middle fiber layer is formed at least by the viscose fibers;

(2) applying the spunbond filaments to at least one side of the middle fiber layer through a spunbond process, which comprises the following steps: a thermoplastic resin is heated and melted, and the thermoplastic resin heated and melted is introduced into a spinning device; the thermoplastic resin heated and melted is made into melt trickles in the spinning device, and then the melt trickles eject through a spinneret of the spinning device, and then cooled by side-blowing cold air to form the spunbond filaments; the spunbond filaments are then drawn through a fiber drawing device and then intertwine with a corresponding side of the middle fiber layer to form a spunbond filament layer on the corresponding side of the middle fiber layer, thereby forming a multilayer fiber web with at least one of two outer layers being the spunbond filament layer, and a middle layer being the middle fiber layer formed at least by the viscose fibers in between the two outer layers;

(3) consolidating the multilayer fiber web with a heating device to form the spunbond composite wiping non-woven fabric with at least one of the upper surface layer and the lower surface layer being the spunbond filament layer, and a middle layer being said middle fiber layer formed at least by the viscose fibers.

In step (2), applying melt-blown fibers to another side of the middle fiber layer through a melt-blown process to form the multilayer fiber web which has one of the two outer layers being the spunbond filament layer, and another one of the two outer layers being a melt-blown fiber layer, and the middle layer being the middle fiber layer formed at least by the viscose fibers in between the two outer layers.

In step (1), the viscose fibers are mixed with other fibers to form mixed fibers, which subsequently form the middle fiber layer through the nozzle under the action of auxiliary airflow.

The heating device is a hot air oven, a pair of press rollers, or a combination of both.

In step (2), applying the spunbond filaments to both sides of the middle fiber layer through a spunbond process to form the multilayer fiber web with each of both the two outer layers being the spunbond filament layer, and the middle layer being the middle fiber layer formed at least by the viscose fibers in between the two outer layers.

### Beneficial Effects of the Present Invention

### Beneficial Effects

In accordance with the aforementioned structures and manufacturing method, the middle fiber layer of the composite wiping non-woven fabric is formed at least by the viscose fibers which have a fiber length of approximately 35 mm to 76 mm, whereas the conventional non-woven fabric used for wipes has a middle layer made of wood pulp fibers with a fiber length of approximately 1 mm to 4 mm, viscose fibers with a longer fiber length as the fibers in the middle fiber layer makes it less likely for them to escape from gaps between the fibers of the upper and lower layers. In addition, during the manufacturing process of the composite wiping non-woven fabric, the spunbond filaments on one side of the middle fiber layer, and the spunbond filaments or the melt-blown fibers on another side of the middle fiber layer intertwine with the two sides of the middle fiber layer respectively, thereby forming an interwoven network structure, that is to say, there are fiber interlacing and intertwining areas between the upper layer and the middle fiber layer, and also between the lower layer and the middle fiber layer. Accordingly, the viscose fibers of the middle fiber layer are fixed within the interwoven network structure, making the viscose fibers difficult to move. This prevents the occurrence of “shedding” or “dusting” during use, and further effectively prevents the occurrence of agglomeration of fibers in the middle fiber layer after absorbing water when the composite wiping non-woven fabric is used with liquids. Moreover, presence of spunbond filaments enhances the mechanical properties of the composite wiping non-woven fabric, making it more suitable for use in the fields such as makeup removal, facial cleansing, and stain removal.

### BRIEF DESCRIPTION OF THE DRAWINGS

FIG. 1 is a schematic diagram of the manufacturing of the spunbond composite wiping non-woven fabric according to Embodiment 1 of the present invention.

FIG. 2 is a cross-sectional view of the spunbond composite wiping non-woven fabric made according to Embodiment 1 of the present invention.

FIG. 3 is a schematic diagram of the manufacturing of the spunbond composite wiping non-woven fabric according to Embodiment 2 of the present invention.

FIG. 4 is a cross-sectional view of the spunbond composite wiping non-woven fabric made according to Embodiment 2 of the present invention.

### DETAILED DESCRIPTION OF THE INVENTION

### Embodiments of the Present Invention

In order to further explain the technical solutions of the present invention, the present invention will be described in detail with some specific embodiments.

### Embodiment 1

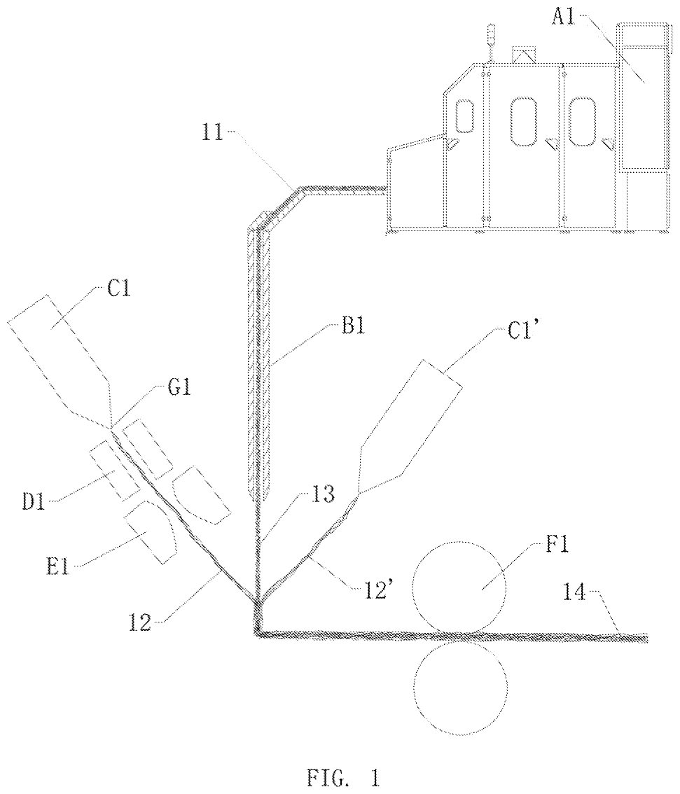

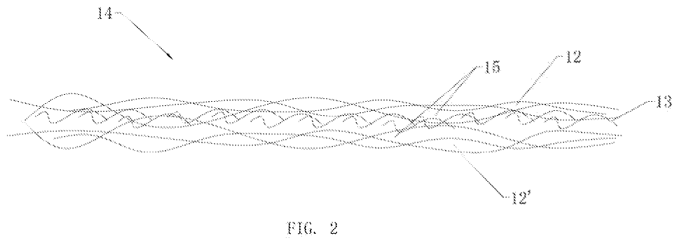

As shown in FIGS. 1 and 2, viscose fibers are carded into a viscose fiber web 11 using a carding machine A1. A middle fiber layer 13 composed of the viscose fibers is formed from the viscose fiber web through a nozzle B1 under action of auxiliary airflow.

Applying spunbond filaments to one side of the middle fiber layer 13 through a spunbond process which comprises the following steps: a thermoplastic polypropylene resin is heated and melted, and the thermoplastic polypropylene resin heated and melted is introduced into a spinning device C1; the thermoplastic polypropylene resin heated and melted is made into melt trickles in the spinning device C1, and then the melt trickles eject through a spinneret of the spinning device, and then cooled by side-blowing cold air D1 to form spunbond filaments; the spunbond filaments are then drawn through a fiber drawing device E1 and then intertwine with said one side of the middle fiber layer 13 to form a spunbond filament layer 12 on said one side of the middle fiber layer 13.

Applying melt-blown fibers to another side of the middle fiber layer 13 through a melt-blown process, which comprises the following steps: a thermoplastic polypropylene resin is heated and melted; melt trickles of the heated and melted thermoplastic polypropylene resin are ejected out from a spinneret C1, and hot air is used to blow the melt trickles ejected out from the spinneret C1′ into ultra-fine fiber bundles, which, together with flows of the hot air, form a melt-blown fiber web layer 12′ that intertwines with said another side of the middle fiber layer 13, thereby forming a multilayer fiber web with two outer layers being the spunbond filament layer 12 and the melt-blown fiber web layers 12′ respectively, and a middle layer being the middle fiber layer 13 formed from the viscose fiber web 11 in between the spunbond filament layer 12 and the melt-blown fiber web layers 12′; apart from the thermoplastic polypropylene resin, the spunbond filaments and the melt-blown fibers used in the above processes can alternatively be single-component propylene fibers, or can also be polyolefin fibers, polyamide fibers, polyurethane fibers, or a mixture thereof; a weight of the viscose fibers is 75% of a total weight of the composite wiping non-woven fabric.

Fiber web layers of the multilayer fiber web are consolidated by a pair of press rollers F1 to form the composite wiping non-woven fabric 14 with an upper layer and a lower layer being the spunbond filament layer 12 and the melt-blown fiber web layers 12′ respectively, and a middle layer being the middle fiber layer 13 formed from the viscose fiber web 11 in between the upper layer and the lower layer, wherein fiber interlacing and intertwining areas exist between the spunbond filament layer 12 and the middle fiber layer 13, and also between the melt-blown fiber web layer 12′ and the middle fiber layer 13.

### Mechanical Property Testing.

Tensile strength testing was conducted using the XLW-100N Intelligent Electronic Tensile Tester with following test parameters.

MD (machine direction): sample width: 50 mm, gauge length: 200 mm, stretching velocity: 100 m/min.

CD (cross direction): sample width: 50 mm, gauge length: 100 mm, stretching velocity: 100 m/min.

### Abrasion Resistance Testing.

Reference standard: Chinese national standard GB/T13775-92 “Testing Method for Determination of the Resistance to abrasion of cotton, ramie and silk spinning fabrics”.

Instrument: YG(B)401E Martindale Abrasion Tester.

Materials used in the Testing.

Standard padding material: standard felt with a square meter weight of 750±50 g/m2, a thickness of 3±0.5 mm, and a diameter of 140 mm.

Sample backing material: polyurethane foam plastic material with a thickness of 3±0.5 mm, a density of 0.04 g/cm3, and a diameter of 38±2 mm.

Sampler 1: disk sampler with a diameter of 140 mm, used for sampling a lower-layer abrasion test sample material with a size of φ140 mm.

Sampler 2: disk sampler with a diameter of 38 mm, used for sampling an upper-layer abrasion test sample material with a size of φ38 mm.

Sample pretreatment: The samples were kept at room temperature for 24 H.

Testing Procedures: 1) Use sampler 1 to take a lower-layer abrasion test sample material with a diameter of 140 mm and place it over the standard padding; then place a sample mounting weight on the lower-layer abrasion test sample material; tighten a circular clamp to fix the lower-layer abrasion test sample material on an abrasion test table.

2) Use sampler 2 to take an upper-layer abrasion test sample material with a diameter of 38 mm, and load the upper-layer abrasion test sample material with a sample holder into a 200 g metal clamp head of an A-type abrasion head, and a polyurethane foam plastic having a diameter of 38 mm is placed between the metal clamp head and the abrasion head.

3) Place the metal clamp head onto the abrasion test table, and pass a core shaft through a bearing of the abrasion head so that the core shaft is inserted into the metal clamp head; then add a 395 g weight on the metal clamp head (a load generated by the 395 g weight plus the weight of the 200 g metal clamp head is 583.1 _{c}N).

4) Set a rotation speed of the instrument to 20 rpm with a total of 15 rotations. After completing the setting, click the “Start” button to start operation of the instrument; once the test is completed according to the setting, the instrument will stop. Inspect the fiber shedding of the lower-layer abrasion test sample material and determine its abrasion resistance level as L (good abrasion resistance), M (moderate abrasion resistance), or H (poor abrasion resistance) based on the shedding condition.

### Dusting Rate Testing.

Instruments: dusting rate tester, balance.

Reference testing standard: Dusting Rate Testing according to Appendix B of Chinese national standard GB/T 20810-2018 concerning “Toilet Tissue Paper”.

Testing steps: 1. Take approximately 150 g of sample, weigh it with the balance, and denote its weight as m1; fold the sample into a specimen of 200 mm in length, with longitudinal edges of the folded portions always in alignment during folding.

2. Fix one end of a longitudinal edge of the eventually folded specimen onto the specimen clamp, with specimen surfaces perpendicular to a swinging direction of the specimen during testing, and ensure that the specimen will not come into contact with inner walls of a chamber of the tester during testing.

3. Start the tester and let the specimen swing inside the chamber for 2 min, with a reciprocating frequency of 180±10 times/min and a swing distance of 100±5 mm.

4. After the test is completed, turn off the tester, remove the specimen, weigh the specimen and denote the weight as m2.

5. Calculate the dusting rate of the specimen according to the following formula: X=(m1−m2)/m1×100.

In the formula: X represents the dusting rate of the specimen in percentage; m1 represents the weight of the specimen before the test in gram (g); m2 represents the weight of the specimen after the test in gram (g).

### Liquid Absorption Testing.

Weigh a 10 cm×10 cm sample and record the weight as M1, then submerge the sample in water to completely wet it, take out the sample 60s later and hang it in air for 120s, and then weigh it again, and then record the weight as M2; calculate a liquid absorption amount as M=M2−M1.

The tests and their methods are used to test the composite wiping non-woven fabric produced according to Embodiment 1 and a conventional wiping non-woven fabric; wherein the conventional wiping non-woven fabric has both upper and lower surface layers being melt-blown non-woven fabric layers and a middle layer formed by wood pulp fibers. The test results are shown below.

| | | Tensile | | Elongation | | | | |
|---|---|---|---|---|---|---|---|---|
| | Gram | strength | | at break | | Abrasion | Dusting | Moisture |
| | weight | MD | CD | MD | CD | resistance | rate | absorption |
| | Unit | | | | | | | |
| | | N/2 | N/2 | | | | | |
| Test item | g/m² | inch | inch | % | % | / | % | g |
| Conventional | 65 | 14.8 | 11.9 | 22.0 | 39.5 | M | 0.25 | 657.2 |
| wiping non- | | | | | | | | |
| woven fabric | | | | | | | | |
| Composite | 65 | 17.6 | 14.5 | 23.5 | 42.8 | L | 0.16 | 684.8 |
| wiping non- | | | | | | | | |
| woven fabric | | | | | | | | |
| of Embodiment 1 | | | | | | | | |

The middle fiber layer of the composite wiping non-woven fabric in Embodiment 1 is formed from viscose fibers with a fiber length of approximately 35 mm to 76 mm, whereas the conventional non-woven fabric used for wipes has a middle layer made of wood pulp fibers with a fiber length of approximately 1 mm to 4 mm. In the dusting rate testing, the severity of the phenomenon so-called “shedding” or “dusting” which fibers in the middle fiber layer drop off from the middle fiber layer through the two outer layers is assessed by side-to-side swinging of the composite wiping non-woven fabric and then determining a percentage of weight difference of the composite wiping non-woven fabric obtained by a ratio between a difference in weight of the composite wiping non-woven fabric before and after swinging and the weight of the composite wiping non-woven fabric before swinging. As can be seen from the above test results, the dusting rate of the composite wiping non-woven fabric in Embodiment 1 is lower than that of the conventional wiping non-woven fabric. Therefore, viscose fibers with a longer fiber length as the fibers in the middle fiber layer make it less likely for them to escape from gaps between the fibers of the upper and lower layers. Moreover, viscose fibers possess good moisture absorption and water retention properties. Due to smaller fiber denier of the melt-blown fibers, the composite wiping non-woven fabric as formed gives a softer feeling and has a large fiber specific surface area, and these enhances the cleaning capability of the composite wiping non-woven fabric during wiping. The presence of spunbond filaments (spunbond filament layer) enhances the mechanical properties of the wiping non-woven fabric, making it more suitable for use in the fields such as makeup removal, facial cleansing, and stain removal.

### Embodiment 2

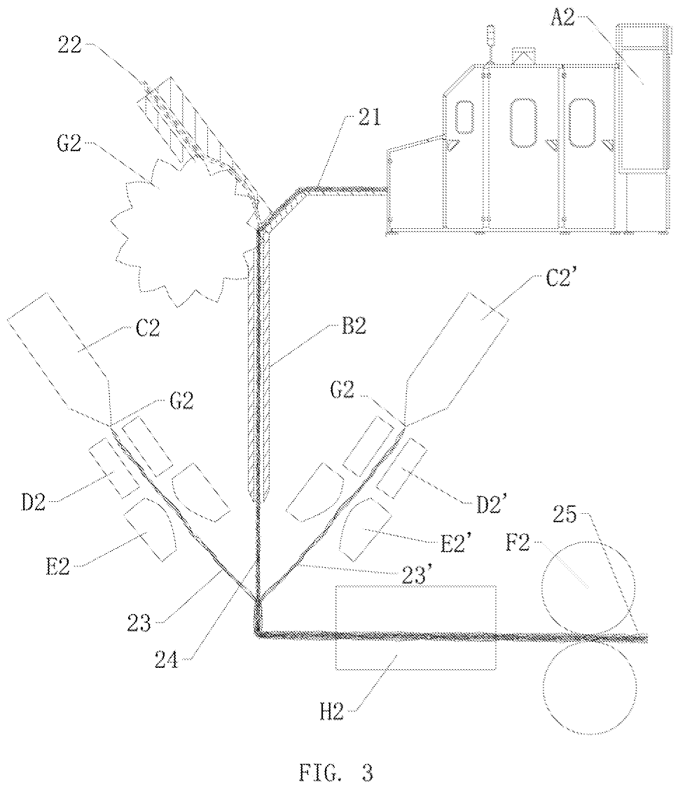

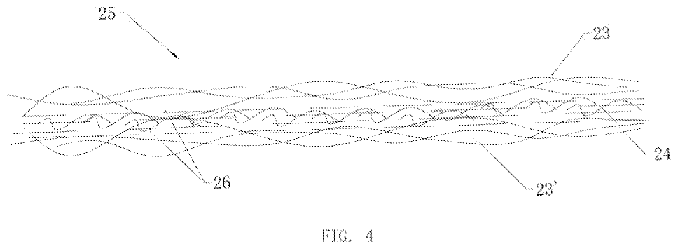

As shown in FIGS. 3 and 4, viscose fibers are carded into a viscose fiber web 21 using a carding machine A2. Wood pulp fibers 22 are opened and loosened by a loosening roller G2; and the wood pulp fibers 22 being opened and loosened are mixed with the viscose fiber web 21 to form a mixture, and then, a middle fiber layer 24 composed of the mixture comprising said wood pulp fibers 22 and the viscose fiber web 21 is formed through a nozzle B2 under action of auxiliary airflow.

Applying spunbond filaments to two sides of the middle fiber layer 24 through a spunbond process, which comprises the following steps: a thermoplastic polypropylene resin is heated and melted, and the thermoplastic polypropylene resin heated and melted is introduced into spinning devices C2 and C2′ corresponding to said two sides of the middle fiber layer respectively; the thermoplastic polypropylene resin heated and melted is made into melt trickles in the spinning devices C2 and C2′, and then the melt trickles eject through spinnerets of the spinning devices, and then cooled by side-blowing cold air D2 and D2′ to form spunbond filaments; the spunbond filaments are then drawn through fiber drawing device E2 and E2′ and then intertwine with said two sides of the middle fiber layer 24 respectively to form spunbond filament layers 23 and 23′ on said two sides of the middle fiber layer 24 respectively. Therefore, a multilayer fiber web is formed with two outer layers being the spunbond filament layers 23 and 23′ respectively, and a middle layer being the middle fiber layer 24 formed by the mixture of the wood pulp fibers and the viscose fibers in between the spunbond filament layers 23 and 23′; as said, the spunbond filaments of the spunbond filament layers 23 and 23′ are polypropylene (PP) fibers, but they can also be polyamide fibers, polyurethane fibers, or a mixture thereof; the PP fibers are bi-component spunbond filaments with an outer surface of each filament at least partially formed by a low melting point resin, specifically, the bi-component spunbond filaments can be bi-component sheath-core type fibers, bi-component orange peel type fibers, or bi-component side-by-side type fibers; a weight of the middle fiber layer is 80% of a total weight of the composite wiping non-woven fabric; 60% by weight of the middle fiber layer is the viscose fibers; also, besides wood pulp fibers, fibers that can also be mixed with the viscose fibers in the middle fiber layer may be single-component or bi-component staples, or other kinds of natural fibers, etc.

The multilayer fiber web is first put into a hot air oven H2, such that the outer surface (which is at least partially formed by said low melting point resin) of the bi-component PP fibers in upper and lower layers of the multilayer fiber web can be melted by hot air in the hot air oven to bond the fibers in the upper and lower layers respectively. Then, the multilayer fiber web is further consolidated with a pair of press rollers F2 to form a spunbond composite wiping non-woven fabric 25 with the upper and lower layers being the spunbond filament layers 23 and 23′ and a middle layer in between the spunbond filament layers 23 and 23′ being the middle fiber layer 24 formed by a mixture of the viscose fiber web 21 and the wood pulp fibers 22, wherein fiber interlacing and intertwining areas exist between a first spunbond filament layer 23 and the middle fiber layer 24, and also between a second spunbond filament layer 23′ and the middle fiber layer 24.

The spunbond composite wiping non-woven fabric produced in Embodiment 2 and a conventional wiping non-woven fabric (which has both upper and lower surface layers being melt-blown non-woven fabric layers and a middle layer formed by wood pulp fibers) were subjected to tests and evaluations. The test results are shown below.

| | | Tensile | | Elongation | | | | |
|---|---|---|---|---|---|---|---|---|
| | Gram | strength | | at break | | Abrasion | Dusting | Moisture |
| | weight | MD | CD | MD | CD | resistance | rate | absorption |
| | Unit | | | | | | | |
| | | N/2 | N/2 | | | | | |
| Test item | g/m² | inch | inch | % | % | / | % | g |
| Conventional | 65 | 14.8 | 11.9 | 22.0 | 39.5 | M | 0.25 | 704.1 |
| wiping non- | | | | | | | | |
| woven fabric | | | | | | | | |
| Spunbond | 65 | 18.5 | 15.4 | 24.2 | 40.5 | L | 0.22 | 703.6 |
| composite | | | | | | | | |
| wiping non- | | | | | | | | |
| woven fabric | | | | | | | | |
| of Embodiment 2 | | | | | | | | |

The spunbond composite wiping non-woven fabric produced according to the aforementioned structures and manufacturing method has both upper and lower layers being the spunbond filament layers. The presence of spunbond filaments (filaments) enhances the mechanical properties of the spunbond composite wiping non-woven fabric, providing toughness even when wet, which makes it suitable for use in the fields such as makeup removal, facial cleansing, and stain removal, and prevents issues of breaking or tearing of the wiping non-woven fabric during use. The middle fiber layer 24 is formed by a mixture of the viscose fiber web 21 and the wood pulp fibers 22, wherein the wood pulp fibers may also be replaced with other fibers such as single-component or bi-component staples, or other kinds of natural fibers. Addition of other fibers imparts more characteristics to the composite wiping non-woven fabric. For example, wood pulp fibers, due to their high specific surface area, can further enhance the moisture absorption of the composite wiping non-woven fabric; single-component or bi-component staples, such as CoPET staples, PE/PET or PE/PP staples, can further enhance the abrasion resistance of the composite wiping non-woven fabric, preventing fiber shedding; and the inclusion of natural fibers like cotton fibers can improve the softness and skin-friendly properties of the composite wiping non-woven fabric.

1. A spunbond composite wiping non-woven fabric with a layered structure, comprising sequentially an upper surface layer, a middle fiber layer, and a lower surface layer; at least one of the upper surface layer and the lower surface layer is formed by spunbond filaments, and the middle fiber layer is formed at least by viscose fibers, wherein a weight of the middle fiber layer is greater than or equal to 65% of a total weight of the spunbond composite wiping non-woven fabric; the viscose fibers have a fiber length of 35 mm to 76 mm, and there are fiber interlacing and intertwining areas between the upper surface layer and the middle fiber layer, as well as between the lower surface layer and the middle fiber layer.

2. The spunbond composite wiping non-woven fabric of claim 1, wherein the spunbond filaments are polyolefin fibers, polyamide fibers, polyurethane fibers, or a mixture thereof.

3. The spunbond composite wiping non-woven fabric of claim 1, wherein the spunbond filaments are single-component spunbond filaments, bi-component spunbond filaments with outer surface of each filament at least partially formed by low melting point resin, or a mixture thereof.

4. (canceled)

5. The spunbond composite wiping non-woven fabric of claim 1, wherein the middle fiber layer is formed by a mixture of viscose fibers mixed with natural fibers, single-component staples, bi-component staples, or a mixture thereof.

6. The spunbond composite wiping non-woven fabric of claim 5, wherein a weight percentage of the viscose fibers in the middle fiber layer is greater than or equal to 15%.

7. The spunbond composite wiping non-woven fabric of claim 5, wherein the natural fibers are wood pulp fibers, cotton fibers, or a mixture thereof.

8. The spunbond composite wiping non-woven fabric of claim 1, wherein another one of the upper surface layer and the lower surface layer is also formed by spunbond filaments.

9. The spunbond composite wiping non-woven fabric of claim 1, wherein another one of the upper surface layer and the lower surface layer is formed by melt-blown fibers.

10. (canceled)

11. (canceled)

12. (canceled)

13. (canceled)

14. (canceled)
